(19) United States
(12) Patent Application Publication
(10) Pub. No.: US 2007/0054132 A1
(43) Pub. Date: Mar. 8, 2007

(54) Ceramic device and method for making the same

(76) Inventors: William J. LaBarge, Bay City, MI (US); Robert P. Johnston, Davison, MI (US); Fenglian Change, Grand Blanc, MI (US)

Correspondence Address: Paul L. Marshall;Delphi Technologies, Inc., P.O. Box 5052, Mail Code: 480-410-202, Troy, MI, 48007-5052, US

(21) Appl. No.: 11/210,932

(22) Filed: Aug. 24, 2005

(51) Int. Cl. C03B 29/00; C04B 37/00; B32B 17/06; B32B 9/00; B32B 19/00

(52) U.S. Cl. 428/432; 428/701; 428/702; 156/89.11; 156/89.28

(57) ABSTRACT

In one embodiment, a ceramic device comprises: a ceramic substrate, a second substrate, and a bonding agent comprising a metal hydride disposed between the first ceramic substrate and the second ceramic substrate, wherein the metal hydride comprises a first metal selected from the group consisting of palladium, ruthenium, and combinations comprising at least one of the foregoing metals. In one embodiment, a method for making a ceramic device can comprise: disposing the bonding agent between a ceramic substrate and a second substrate to form an assembly and firing the assembly to a temperature above a liquid temperature of the bonding agent.

### BACKGROUND

Systems are being developed in a variety of different technologies that generate hydrogen (e.g., reformers, and the like) or make use of hydrogen (e.g., fuel cells, and the like). Many of the devices comprise a series of stacked plates bonded into an assembly. Generally, these stacked plates employ some type of metallizing (e.g., brazes, solders, electrodes, interconnects, and the like), which can comprise a protective coating. Efficient, effective operation of these systems relies upon the metallized joints and interfaces being leak-free at several atmospheres pressure and temperatures as high as 1,000° C.

For example, an aluminide coating consists of a surface layer of protective aluminum oxide (Al₂O₃ from Al metal) that prevents further oxidation and spallation of the subsurface alloy metals (platinum (Pt), nickel (Ni), etc). Platinum aluminide (PtAl/Al₂O₃), platinum-nickel aluminide (PtNiAl/Al₂O₃), and/or a nickel aluminide (NiAl/Al₂O₃) have been developed for metallized components used in high temperature demanding environments. However, these demanding environments traditionally did not include environments comprising wet hydrogen.

In a wet hydrogen environment, the protective oxide layer can permanently de-bond from the platinum or nickel metal alloy, allowing separation of the ceramic components and failure of the hermetic seal(s) between the interface of the protective oxide layer and intermetallic alloy. The exposed metals are not effective as a high temperature (e.g., temperatures of about 900° C. to about 1,100° C.) oxidation protective layer. This can thereby expedite failure of the component.

An additional issue is the difficulty in brazing or soldering to aluminum oxide and silicon oxide, which is difficult if not impossible. Sintering aids and fluxes could be employed since they remove oxides from the surfaces of the metal particles thereby promoting the wetting of the metal particles. However, these fluxing materials readily diffuse from the center of the braze region into the braze surface where they are easily vaporized in the high temperature wet hydrogen environment.

Therefore, what is needed in the art are improved inks and/or brazing pastes that can be employed in relation to a assembly of metallized ceramic components exposed to both a hydrogen environment and a oxidizing environment at high temperatures.

### SUMMARY

Disclosed herein are ceramic devices, and methods for making ceramic devices. In one embodiment, a ceramic device comprises: a ceramic substrate, a second substrate, and a bonding agent comprising a metal hydride disposed between the first ceramic substrate and the second ceramic substrate, wherein the metal hydride comprises a first metal selected from the group consisting of palladium, ruthenium, and combinations comprising at least one of the foregoing metals.

In one embodiment, the method for making a ceramic device can comprise: disposing a bonding agent between a ceramic substrate and a second substrate to form an assembly and firing the assembly to a temperature above a liquid temperature of the bonding agent. The bonding agent comprises a metal hydride that comprises a metal selected from the group consisting of palladium, ruthenium, and combinations comprising at least one of the foregoing metals.

The above-described and other features will be appreciated and understood by those skilled in the art from the following detailed description, drawings, and appended claims.

### DETAILED DESCRIPTION

It should first be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Furthermore, all ranges disclosed herein are inclusive and combinable (e.g., ranges of “up to about 25 weight percent (wt %), with about 5 wt % to about 20 wt % desired, and about 10 wt % to about 15 wt % more desired,” are inclusive of the endpoints and all intermediate values of the ranges, e.g., “about 5 wt % to about 25 wt %, about 5 wt % to about 15 wt %”, etc.). The modifier “about” used in connection with a quantity is inclusive of the stated value and has the meaning dictated by the context, (e.g., includes the degree of error associated with measurement of the particular quantity).

Disclosed herein are ink compositions and bonding agents compositions that can be employed for metallizing ceramic components, which are capable of being employed in a system or device that can be exposed to wet hydrogen (e.g., during manufacturing, during operation, and the like) in the lifetime of the system or the device. More particularly, these compositions can be used in reforming devices constructed from ceramics, such as co-fired ceramics. Although the ink compositions are discussed hereunder in relation to these ceramic devices operated at high temperatures, it is understood that they can be employed at other temperatures and in other ceramic devices. It is merely noted the particular advantage attained under high temperature conditions. The ceramic component, for example, can be a fuel reforming assembly. The described metal hydride bonding method is applicable to joining metal to metal, metal to ceramic, and/or ceramic to ceramic. For example, the reforming device can comprise an assembly comprising ceramic plates bonded (e.g., brazed) to metal plates, wherein the bonding agent comprises about 0.5 wt % to about 10.0 wt % metal hydride disposed between the ceramic plate and the metal plate.

Palladium is a metal that forms the metal hydride relatively easily and is thus well suited to substantially improve bond agent (e.g., braze) durability in components continuously exposed to wet hydrogen at elevated temperatures. The metal of the metal hydride can be ruthenium, palladium, as well as combinations comprising at least one of the foregoing metals. Desirably, the metal hydride of the bonding agent comprises greater than or equal to about 80 wt %, specifically, greater than or equal to about 90 wt %, or more specifically, greater than or equal to about 95 wt %, and yet more specifically, 100 wt % of palladium hydride and/or ruthenium hydride. In addition to the metal in the metal hydride, the bonding agent can comprise a high temperature metal alloy(s) that include nickel (e.g., greater than or equal to about 50 weight percent (wt %) nickel, based upon the total weight of the metal alloy).

Exemplary alloys include Inconel® (nickel and chromium alloys commercially available from Inco Alloys International Inc., Huntington, W. Va.), Monel® (corrosion resistant alloys of nickel and copper also commercially available from Inco Alloys International Inc.), Hastelloy® (high strength nickel based alloys commercially available from Haynes International Inc., Kokomo, Ind.), and the like, as well as a combination comprising at least one of the foregoing. The amount of nickel in these alloys can be Waspalloy 59.4 wt. % Ni, Udimet 57.4 wt. % Ni, Inconel 64.6 wt. % Ni, Hastealloy® 56.7 wt. % Ni, Nimonic 59.8 wt. % Ni, Rene 55.0 wt. %, Astroloy can comprise 55.0 wt. % Ni, and Haynes 76.5 wt. % Ni. Palladium hydride is capable of wetting oxides such as chromium oxide present at the nickel alloy surface. For example, the bonding agent can comprise about 0.5 wt % to about 10 wt % palladium hydride (PdHₓ), and nickel metal alloy(s) and/or superalloy(s) (e.g., high temperature nickel metal alloy(s) and/or superalloy(s)), wherein the palladium hydride can be a coating on the metal (e.g., the high temperature nickel alloy(s) and/or superalloy(s)). Optionally, the bonding agent can comprise about 0.5 wt % to about 20 wt % palladium hydride (PdHₓ), or, more specifically, about 3 wt % to about 15 wt % palladium hydride, or, even more specifically, about 5 wt % to about 10 wt %, base upon a total weight of the bonding agent.

Metallizing a ceramic involves depositing a metal layer upon a ceramic using such methods as plasma vapor deposition, chemical vapor deposition, plasma spraying, electrode position, etc. Production of monolithic reforming structures depends on the ability of brazing materials to “stick” to the surface of the ceramic material. Most metals such as nickel, copper, titanium, silver, gold, platinum, palladium etc. will not sufficiently wet or stick to the ceramic layers with a sufficient adhesion to remain adhered to the ceramic. Hence, the metallizing is accomplished using a hydride, more specifically palladium hydride, so that the metals sufficiently adhere to the ceramic.

The metallized ceramic can then be soldered, or otherwise processed as desired, e.g., into a monolithic unit. Brazing refers to a process whereby an ink or paste brazing material melts and flows at temperatures above about 500° C. High temperature brazing refers to a process whereby an ink or paste brazing material melts and flows at temperatures above about 800° C. However, since ceramic reformers may operate at temperatures of up to 925° C., depending upon the fuel, brazing of the ceramic components into a monolithic unit depends on ceramic-metal bonding that is stable up to about 1,000° C. or more.

More particularly, it has been discovered that metallized ceramics derived from palladium hydride can be particularly suited to withstand a high temperature reforming environment (i.e., temperatures of greater than or equal to 900° C.). The palladium hydride can be used to metallize the surface of a ceramic component, prior to a bonding process. The palladium hydride metallized ceramic component can then be brazed as desired, e.g., using a nickel containing brazing agent. Alternatively, or in addition, the palladium hydride can be added directly into the bonding paste.

Without being bound by theory, it is believed that the active palladium hydride ingredient dissociates into palladium metal and hydrogen. The reactive palladium metal surface and hydrogen, at high temperature, creates a robust fusion of the nickel metal into a durable alloy. At temperatures beyond about 700° C. static seals made from high nickel content alloys (e.g., alloys comprising greater than or equal to about 50 wt % nickel, based upon a total weight of the alloy) stress relax under compression. Nickel metal alloys that ordinarily would not be capable of surviving in a high temperature hydrogen environment can form very stable alloys in the presence of a palladium hydride, which can allow for a variety of metals to be employed in the ink composition and brazing paste. Reaction of these alloys with palladium hydride prevents coarsening of the gamma prime precipitates thereby inhibiting the stress relaxation until much higher temperatures (e.g., temperatures exceeding about 1,200° C.).

Suitable hydrides include ruthenium hydride, palladium hydride, ruthenium hydride alloy, palladium hydride alloy, as well as combinations comprising at least one of palladium hydride and rhodium hydride, such as palladium hydride, ruthenium hydride, palladium hydride-silver, ruthenium hydride-silver, palladium hydride-titanium, ruthenium hydride-titanium, palladium hydride-copper, ruthenium hydride-copper, palladium hydride-nickel, ruthenium hydride-nickel, palladium hydride-platinum, ruthenium hydride-platinum, palladium hydride-gold, ruthenium hydride-gold and combinations comprising one or more of the foregoing hydrides.

In order to enhance the benefits of the ruthenium hydride and/or palladium hydride, the hydride employed can be formed before forming the alloy to prevent formation of the metal into a hydride. In other words, such that the palladium and/or ruthenium are hydride(s), while the other metal(s) of the alloy are not hydrides. For example, the process to convert palladium into palladium hydride is completed before mixing palladium hydride with other metal(s), thereby preventing the formation of the other metals into hydrides. As such, hydrides such as titanium hydride, zirconium hydride or vanadium hydride are not formed when palladium hydride is mixed with the metal powder (e.g., titanium metal powder).

For ink compositions, in addition to the metal hydride(s), the ink composition can also comprise binder(s), carrier(s), wetting agent(s), and the like, and combinations comprising at least one of the foregoing. The binder can be any material capable of providing temporary adhesion between the ink and a ceramic component on which the ink is to be applied (e.g., a substrate). Suitable binders include acrylic resin, acrylonitrile, styrene, acrylic acid (e.g., methacrylic acid, and the like), acrylates (e.g., methyl acrylate, methyl methacrylate, and the like), and the like, as well as combinations comprising at least one of these binders.

The carrier can include any material suitable for imparting desired printing and drying characteristics of the ink. In general, the carrier can include a polymer resin dissolved in a volatile solvent. The wetting agent can include ethanol, isopropyl alcohol, methanol, cetyl alcohol, and the like, as well as combinations comprising at least one of the foregoing.

As noted above, the ink compositions and brazing pastes compositions disclosed herein are capable of being employed in any system or device that can be exposed to hydrogen. For example, suitable applications include, but are not limited to, fuel reformers (e.g., preferential oxidation (PROx) reformers, partial oxidation (POx) reformers, and the like), vaporizers, and solid oxide fuel cells (SOFCs).

A low temperature co-fired ceramic generally can comprise a glass and a ceramic material, which can be formed from a mixture of the glass and the ceramic materials with an organic binder and solvent. The mixture can be cast and cut to form “green tapes”. The green tapes can be stacked on top of each other, laminated, and fired (e.g., a temperature less than about 1,000° C., particularly a temperature of about 600° C. to about 800° C.). Alternatively, the laminated green tapes can be printed upon with hydride containing ink. The laminated tapes can then be stacked into a monolithic assembly that can be cofired, e.g., in a nitrogen atmosphere to prevent oxidation of the metal hydride bonding agent.

The ceramic material to be metallized can include metal oxides such as aluminum oxide (Al₂O₃), zirconium oxide (ZrO₂), titanium oxide (TiO₂), fused silica (SiO₂), and the like, as well as combinations comprising at least one of the foregoing, e.g., zirconium-aluminum oxide (ZrO₂—Al₂O₃), mullite (3Al₂O₃·SiO₂), and the like. Alternatively, or in addition, the ceramic can comprise nitrides (such as aluminum nitride (AlN), silicon nitride (Si₃N₄), boron nitride (BN)), carbides (such as silicon carbide (SiC), and the like), and the like, as well as combinations comprising at least one of the foregoing.

The ceramic can further comprise a glass fluxing material, e.g., that reduces the sintering temperature of the ceramic. The fluxing materials can comprise M³⁺ fluxing cations (such as La³⁺, Y³⁺, B³⁺, and the like), and the like as well as combinations comprising at least one of the foregoing. For example a single M³⁺ fluxing agent may be added to the ceramic materials described above thereby forming composite ceramics such as lanthanum aluminate (LaAlO₃), lanthanum zirconate (La₂Zr₂O₇), yttrium stabilized zirconia (Y₂O₃—ZrO₂), yttrium zirconate (Y₂Zr₂O₇), lanthanum-zirconium-aluminum oxide (La₂O₃—ZrO₂—Al₂O₃), yttrium-zirconium-aluminum oxide (Y₂O₃—ZrO₂—Al₂O₃), and the like. The ceramic can comprise mixtures of two or more M³⁺ fluxing cations such as the metal lanthanum titanate-yttrium titanate (LaTiO₃—YTiO₃), lanthanum-boron-aluminum oxide (La₂O₃—B₂O₃—Al₂O₃), and the like. Optionally, though less desirable for high temperature applications, the ceramic can comprise a mixture of M³⁺ with M²⁺ and/or M¹⁺ fluxing cations, for example the ceramic can comprise boron-barium-aluminum-silicate (B₂O₃—BaO—Al₂O₃—SiO₂), lanthanum-boron-aluminum oxide (La₂O₃—B₂O₃—Al₂O₃), and the like.

It is understood that the palladium and ruthenium hydrides are particularly useful for high temperature systems, but can be employed in other systems. For example, the ceramic can comprise a Low Temperature Cofired Ceramic (LTCC). For example, M²⁺ cations may be added to the ceramic materials described above forming, for example, barium-aluminum-silicate (BaO—Al₂O₃—SiO₂), calcium-aluminum-silicate (CaO—Al₂O₃—SiO₂), magnesium-aluminum-silicate (MgO—Al₂O₃—SiO₂), and the like. Even less desirable in high temperature applications, the ceramic formulations may contain M¹⁺ cations such as lithium-aluminum-silicate (Li₂O—Al₂O₃—SiO₂), sodium-aluminum-silicate (Na₂O—Al₂O₃—SiO₂), and the like. The ceramics can also comprise mixtures of M¹⁺ and M²⁺ cations such as lithium-magnesium-aluminum-silicate (Li₂O—MgO—Al₂O₃—SiO₂), potassium-magnesium-aluminum-silicate (K₂O—MgO—Al₂O₃—SiO₂), and the like, as well as combinations comprising at least one of the foregoing. In one embodiment, the substrate can comprise about 86 wt % to about 99.5 wt % aluminum oxide (Al₂O₃), and less than or equal to about 4 wt % silicon oxide (SiO₂; e.g., about 0.05 wt % to about 4 wt % SiO₂), wherein the weight percent is based on a total weight of the sintered substrate.

Suitable binders for palladium hydride bonding agent can include inorganic and/or organic binders. Suitable inorganic binders leave an inorganic residue for example, glass and/or ceramic materials. Possible inorganic binders include zirconium carboxylates, zirconium 2-ethyl hexanoate, zirconium neodecanoates, zirconium naphthenates, zirconium tallates, yttrium carboxylates, yttrium 2-ethyl hexanoate, yttrium neodecanoates, yttrium naphthenates, yttrium tallates, aluminum isopropoxide, aluminum 2-methoxyethanol, aluminum 2-ethylhexanoate, and the like, as well as combinations comprising at least one of the foregoing. Suitable organic binders include, for example, thermoplastics, curable polymers, and the like, as well as combinations comprising at least one of the foregoing.

Suitable solvents include those solvents discussed above in relation to the carriers of the ink composition. Desirably, the particular organic binder(s) and solvent(s) employed undergo combustion at temperatures below the brazing temperature and leave no residue.

The bonding agent alloy can comprise a mixture of palladium hydride powder and nickel based alloy powder in an organic matrix, such as those employed for screen print inks. More specifically, a palladium hydride coated nickel based alloy particle(s) can form the composite powder that can be used to bond ceramic components of a fuel reforming system. If used, the nickel based alloy powder can be present in an amount of greater than or equal to about 40 wt % nickel based alloy powder, more specifically, greater than or equal to about 55 wt % nickel based alloy powder, and even more specifically, greater than or equal to about 75 wt % nickel based alloy powder, based upon a total weight of the palladium and nickel based alloy powder. For example, the bonding agent can comprise about 40 wt % to about 95 wt % nickel, or, more specifically, about 55 wt % to about 90 wt % nickel, or, even more specifically, about 75 wt % to about 85 wt % nickel. Suitable nickel based alloys include alloys such as 625, 622 or 690 and super alloys such as Waspaloy® (commercially available from Allvac of Monroe, N.C.), Inconel® 718, Udimet® 720 and Rene®-41. The suitable nickel based alloy powders can be present in an amount of greater than or equal to about 50 wt % nickel, more specifically, greater than or equal to about 55 wt % nickel, and even more specifically, greater than or equal to about 60 wt % nickel, based upon a total weight of the nickel based alloy powder.

It is further noted that since hydrogen can react with carbides in the bonding agent to form methane gas (C+H₂→CH₄) that can weaken the bond through the introduction of porosity, lower carbon/carbide content alloys are desired. Desirably, the carbon content is less than or equal to about 0.03 wt % is desirable, and more specifically, less than or equal to about 0.01 wt %, based upon a total weight of the bonding agent.

As with the carbon/carbide, aluminide and silicide protective coatings are not stable in hydrogen environment. Therefore, the alloy (e.g., the nickel based alloy) contains less than or equal to about 4 wt % combined aluminum (Al) and silicon (Si) (such as Rene alloys), more specifically, less than or equal to about 3 wt % Al and Si (such as Udimet alloys), and even more specifically, less than or equal to about 2 wt % Al and silicon Si (such as Waspaloy alloys), based upon the total weight of the alloy. Unless specified otherwise, weight percent references to the alloy are exclusive of the hydride.

The LTCC can be metallized to form an electrode, a circuit, and the like, on the LTCC by any suitable method. For example, suitable techniques include chemical vapor deposition, screen printing, spraying, painting, dipping, laminating, sputtering, and stenciling, among others, with screen printing being particularly useful in disposing electrodes on the LTCC due to simplicity, economy, and compatibility with the subsequent firing process that can be used to remove the organics from the ink composition used in screen printing. Alternatively, the bonding agent may be in the form of a tape or foil. Tape or foil may be formed from tape casting a slurry of metal powder and organic binder in a organic solvent.

The thickness of the palladium hydride metallizing layer can be about 0.3 micrometers (μm) to about 45 μm, or, more specifically, about 3 μm to about 7 μm. In another embodiment, e.g., wherein the bonding agent comprises less than 100 wt % palladium hydride, the thickness of the bonding layer can be about 20 μm to about 250 μm. When the bonding agent comprises the a mixture of palladium hydride particles and nickel alloy particles, it is beneficial for the largest particles in the mixture to be less than or equal to about 65 μm, measured along the major axis, or, more specifically, less than or equal to about 28 μm. In another embodiment, e.g., if palladium hydride coated nickel alloy particles are used, the composite particles can have a size of less than or equal to about 75 μm.

The bonding can be accomplished in an oxygen-free brazing furnace using argon, dry hydrogen, and/or ammonia gas. The bonding can also be accomplished in an oxygen-free vacuum furnace. The assembly including bonding agent can be heated to above the liquid temperature of the bonding agent, e.g., greater than or equal to about 1,250° C. The assembly can be fired to a temperature of less than or equal to about 1,500° C., or, more specifically, a temperature of less than or equal to about 1,400° C., and even more specifically, a temperature of about 1,300° C. to about 1,350° C.

It is advantageously noted that metallized components comprising palladium hydride can have an increase lifetime in a hydrogen environment compared to metallized components that do not comprise palladium hydride. Accordingly, the lifetime of the device comprising the metallized component can also be increased.

In a reformer assembly, one side of the bonding agent can be exposed to oxidizing gas and the other side of the bonding agent can be is exposed to reducing gas (fuel, reformate). Diffusion of oxygen from one side of the braze and hydrogen from the other side of the bonding agent causes the formation of water (steam) within the center of the bonding agent. The water (steam) can rapidly degrade the bond integrity. Not to be limited by theory, it is believed that a palladium hydride containing bonding agent alloy reacts with and decomposes water, resulting in improved adhesion, reduced oxidation, reduced contamination, and improved mechanical durability of the ceramic reformer. An assembly where both sides of the flat plate structures are exposed to oxidizing gasses, or both sides of the flat plate structures are exposed to reducing gasses, may have excellent durability because the bonding agent alloy is exposed to the same gas species on both sides.

When a palladium containing bonding agent alloy is exposed to high pressure reformate, initially hydrogen (H₂) gas is physically adsorbed on the surface of the palladium (i.e., bonding between hydrogen and the palladium surface by weak van der Waals forces (Pd—H₂)). The adsorbed hydrogen then chemically reacts with and is absorbed by the palladium forming palladium hydride (PdHx). Any water (e.g., steam) formed within the bonding agent is decomposed by interacting with the ample subsurface hydride pool according to the equation H⁻+H₂O→H₂+OH⁻. As hydrides are consumed by the reaction with the water, fresh hydride diffuses from hydrogen rich side of the bonding agent towards the center region of the bonding agent.

### EXAMPLE I

### Palladium Hydride Mixed With Nickel Superalloy

One gram of palladium metal particles having an average size (measured along a major diameter) of 7 micrometers in diameter were loaded into a dense alumina ceramic boat 110 millimeters (mm) by 75 mm by 15 mm (110 mm×75 mm×15 mm). The palladium particles and alumina boat were placed into a 25 mm inner diameter (I.D.) dense alumina tube. The palladium particles were exposed to a 4 volume percent (vol %) H₂/Ar gas mixture at 470° C. for 45 minutes, thereby producing palladium hydride particles. The palladium hydride particles were cooled to room temperature over a period of 1 hour with continued exposure to the 4 vol % H₂/Ar gas mixture.

The palladium hydride particles were dry-mixed with 25 grams Waspaloy® stainless steel powder particles screened to less than 325 mesh (44 micrometers). Additionally 0.3 grams (g) benzoic acid was added-to the mixture. The powders were mixed and then ball milled for a period of 4 hours using 3 mm diameter dense zirconia milling media under cover of an argon atmosphere.

After ball milling, 4.0 grams toluene, 7.0 grams Texanol (2,2,4-trimethyl-1,3-pentanediol monoisobutyrate, propionic acid, 2-methyl-, monoester with 2,2,4-trimethyl-1,3-pentanediol, isobutyric acid ester with 2,2,4-trimethyl-1,3-pentanediol), and 0.2 grams Cellosolve® (e.g., 2-methoxyethanol commercially available from Union Carbide, Danbury, Conn.) were added to the palladium hydride-Waspaloy powder mixture. The mixture was shaken for 20 minutes. The resulting “ink” was collected and passed through a 3-roll mill to thoroughly distribute the palladium hydride-nickel alloy particles evenly through the organics. The homogenized ink was collected as a screen printable paste.

A thin 70 micrometer film of palladium hydride-nickel alloy paste was screen printed on 75 mm×7 mm×1 mm densified aluminum oxide ceramic plate consisting of 96 wt % aluminum oxide. A second 75 mm×7 mm×1 mm ceramic plate was placed over the first ceramic plate. The ceramic plates were cleaned so that the palladium hydride based ink had better adherence to the surface. A dense zirconia ceramic weight 75 mm×7 mm×15 mm was placed on top of the two plates to apply a clamping pressure. The weight was not brazed to the 75 mm×7 mm×1 mm ceramic plates. The stacked assembly was then loaded into a 1 inch diameter tube furnace and dried at 70° C. for 15 minutes.

The ceramic plates with palladium hydride based ink were heated at a rate of 3° C. per minute to a temperature of 175° C. in ambient air in order to combust the screen print ink organics. The ceramic plates were subsequently heated in an atmosphere of 3 vol % hydrogen and dry nitrogen up to 1,180° C. over a period of 120 minutes, held at 1,180° C. for 20 minutes, cooled 7° C. per minute to 1,000° C., and then further cooled at 15° C. per minute to room temperature. The two 75 mm×7 mm×1 mm ceramic plates were fused together with a palladium containing alloy that was able to bond to both alumina surfaces through liquid phase diffusion bonding.

### EXAMPLE II

### Palladium Hydride Mixed With Commercial Braze Alloy

1.7 grams of palladium hydride particles made as describe in Example I, were dry-mixed with 25 grams Amdry 718B (52 atomic percent (at. %) Ni, 18.5 at. % Cr, 18 at. % Fe, 5 at. % Ta, 3 at. % Mo, 2.5 at. % B, 1 at. % Ti) braze alloy. The Amdry 718B particles were screened to 325 mesh (44 micrometers). Additionally 7.8 grams Texanol and 0.2 grams Cellosolve® acetate were added to the palladium hydride-Amdry 718B paste mixture. The resulting “ink” was stirred, collected and passed through a 3-roll mill to thoroughly distribute the palladium hydride throughout the braze paste. The homogenized braze paste was collected as a screen printable ink paste.

A thin 90 micrometer film of palladium hydride-Amdry 718B paste mixture was screen printed on 75 mm×7 mm×1 mm densified aluminum oxide ceramic plate consisting of 96 wt % aluminum oxide. A second 75 mm×7 mm×1 mm ceramic plate was placed over the first ceramic plate. A dense zirconia ceramic weight 75 mm×7 mm×15 mm was placed on top of the two plates to apply a clamping pressure. The weight was not brazed to the 75 mm×7 mm×1 mm ceramic plates. The stacked assembly was then loaded into a 1 inch diameter tube furnace and dried at 70° C. for 15 minutes.

The ceramic plates with the palladium hydride-Amdry 718B braze paste mixture based ink were heated in an nitrogen atmosphere a rate of 7° C. per minute to a temperature of 1,105° C. and held at 1,105° C. for 20 minutes to equalize temperature of the assembly. The ceramic plates were subsequently heated in an nitrogen atmosphere up to 1,255° C. a rate of 2° C. per minute, held at 1,255° C. for 20 minutes, cooled at 2° C. per minute to 1,075° C., and then cooled at 15° C. per minute to room temperature. The two 75 mm×7 mm×1 mm ceramic plates were fused together with a palladium containing alloy that was able to bond to both alumina surfaces through liquid phase diffusion bonding.

### EXAMPLE III

### Palladium Hydride Coated Alumina Substrate

Palladium metal was deposited onto 4 flat plate structures by immersing the plates, made from 99.5 wt % aluminum oxide (Al₂O₃), into one liter of a 0.265 wt % aqueous palladium nitrate solution (Pd(NO₃)₂(H₂O)₂). The concentration of palladium ions was 2.5×10⁻² moles per liter (mole/L). The reducing agent, hydrazine dihydrochloride (NH₂ NH₂·2HCl) 5.24 grams, was dissolved in 125 milliliters per liter (ml/L) of 29.2 vol % ammonium hydroxide solution (pH>0) was drop wise added to the palladium nitrate solution to precipitate palladium metal. The concentration of hydrazine was 5.0×10⁻² mole/L. The solution was heated to 85° C. and the immersed flat plate structures were allowed to soak at that temperature for a period of 2 hours. The plates were removed from the solution, washed with distilled water, and then dried at 80° C. for 1 hour. A palladium metal film was evident on the surfaces of the flat plate structure.

The 4 plates were placed in a stainless steel reactor. A 4 vol % hydrogen balance nitrogen atmosphere was pumped into the 21° C. chamber until the pressure increased to about 125 pounds per square inch (psi). The reactor chamber was heated to about 40° C. Forty minutes after the temperature was raised to 40° C., the chamber was cooled to 21° C. At 21° C. the gaseous hydrogen balance nitrogen was vented from the reactor chamber. The palladium hydride coated aluminum oxide ceramic plates were removed from the reactor.

### EXAMPLE IV

### Palladium Hydride—Nickel Coated Alumina Substrate

To a 500 ml nalgene bottle were added 48.0 grams of 200-250 mesh palladium black powder, 452.0 grams of 200-250 mesh INCO nickel powder, 187 ml denatured absolute ethanol, 2.67 g fish oil, 0.85 g polyvinyl butanol (PVB), 1.4 g butylacetate, 4.0 g dibutyl phthalate and 2.9 g ethyl cellulose were shaken until dissolved and then ball milled for 45 minutes.

A 88 wt % purity, 40 mm×116 mm×2 mm alumina flat plate structure was then immersed in the alcohol slurry of palladium and nickel powder, held for 15 seconds, and then withdrawn. A palladium-nickel layer 45 micrometers thick was deposited onto the surface. Following the deposition, the palladium-nickel coated substrate was dried in air and then fired in a 4 vol % hydrogen balance nitrogen atmosphere at a temperature of 1,240° C., and held for two hours.

### EXAMPLE V

### Palladium Hydride Coated Nickel Superalloy

The nickel-based superalloy Waspaloy as a 325 mesh powder was brought into contact with a solution of 11.2 wt % palladium acetylacetonate dissolved in acetone. The acetone was slowly evaporated off by vacuum methods (vacuum pressure of 10⁻³ Pascals (Pa)) leaving a palladium acetylacetonate coating on the Waspaloy alloy.

The palladium acetylacetonate coating was decomposed in argon at 300° C., thereby making a palladium coated waspaloy alloy. (Palladium acetylacetonate decomposes to palladium at temperatures between 100° C. and 200° C.) The palladium-waspalloy mixture was cooled to room temperature. The palladium coating was chemically reduced to a palladium hydride coating using a hydrogen atmosphere at 50 psi and 25° C.

The palladium hydride coated Waspaloy alloy was mixed with organics typically used for screen printing pastes and the mixture was mixed into an active brazing material. A thin film of the palladium hydride-Waspaloy alloy was screen printed on 96 wt % purity aluminum oxide ceramic plates and then dried in an infrared oven at 90° C. for 15 minutes.

The ceramic plates coated with the palladium hydride braze were heated a rate of 3° C. per minute to a temperature of 225° C. in order to combust the screen print ink organics. The ceramic plates were subsequently heated in an atmosphere of dry argon atmosphere up to 1,200° C. over a period of 4 hours.

The bonding agent and methods disclosed herein can be employed to form ceramic devices, such as reformers. For example, in one embodiment, a ceramic reforming device comprises greater than or equal to 10 ceramic substrates, with the bonding agent disposed between adjacent substrates. The substrates can be green substrates with the bonding agent disposed between adjacent substrates to form an assembly. The assembly can then be heated to a sufficient temperature to calcine the assembly (e.g., to a temperature sufficient to liquefy the bonding agent), thereby forming a reforming device comprising flow paths for liquid hydrocarbons and oxidants (air) and reformed products (hydrogen, carbon monoxide and water). The monolithic reforming device comprises the fired product of the bonding agent.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ceramic device, comprising:
a ceramic substrate;
a second substrate; and
a bonding agent disposed between the first ceramic substrate and the second ceramic substrate, wherein the bonding agent comprised a metal hydride before firing, and wherein the metal hydride comprises a first metal selected from the group consisting of palladium, ruthenium, and combinations comprising at least one of the foregoing metals.

2. The ceramic device of claim 1, wherein the second substrate comprises a ceramic.

3. The ceramic device of claim 1, wherein the metal hydride is a metal hydride-second metal, and wherein the second metal is selected from the group consisting of silver, titanium, copper, nickel, platinum, gold, and combinations comprising at least one of the foregoing.

4. The ceramic device of claim 3, wherein the second metal comprises the nickel.

5. The ceramic device of claim 4, wherein the second metal comprises a nickel alloy.

6. The ceramic device of claim 4, wherein the second metal comprises a nickel superalloy.

7. The ceramic device of claim 3, wherein the metal hydride-second metal is a metal hydride coated second metal.

8. The ceramic device of claim 1, wherein the metal hydride in the bonding agent consists essentially of palladium hydride.

9. The ceramic device of claim 1, wherein the device is a fuel reformer.

10. The ceramic device of claim 1, wherein, before firing, the bonding agent comprised:
less than or equal to about 0.03 wt % carbon;
less than or equal to about 4 wt % combined aluminum and silicon; and
about 0.5 wt % to about 20 wt % metal hydride.

11. The ceramic device of claim 1, wherein the metal hydride is palladium hydride and/or ruthenium hydride.

12. A method for making a ceramic device, comprising:
disposing a bonding agent between a ceramic substrate and a second substrate to form an assembly, wherein the bonding agent comprises a metal hydride that comprises a first metal selected from the group consisting of palladium, ruthenium, and combinations comprising at least one of the foregoing metals; and
firing the assembly to a temperature above a liquid temperature of the bonding agent.

13. The method of claim 12, wherein forming the bonding agent further comprises combining the metal hydride with a second metal to form a palladium hydride—second metal bonding agent.

14. The method of claim 13, wherein the second metal is selected from the group consisting of nickel, platinum, gold, titanium, silver, copper, and combinations comprising at least one of the foregoing.

15. The method of claim 14, wherein the second metal comprises the nickel.

16. The method of claim 13, wherein the second metal comprises a nickel alloy.

17. The method of claim 13, wherein the metal hydride-second metal is a metal hydride coated second metal.

18. The method of claim 12, wherein the bonding agent comprises:
less than or equal to about 0.03 wt % carbon;
less than or equal to about 4 wt % combined aluminum and silicon; and
about 0.5 wt % to about 20 wt % metal hydride.

19. The method of claim 12, wherein the metal hydride is palladium hydride and/or ruthenium hydride.

20. A device formed from the method of claim 12.
